(19) United States
(12) Patent Application Publication
(10) Pub. No.: US 2015/0020943 A1
(43) Pub. Date: Jan. 22, 2015

(54) Low-Metal Tire

(71) Applicant: Bridgestone Americas Tire Operations, LLC, Nashville, TN (US)

(72) Inventors: Jon I. Stuckey, Louisville, OH (US); Kathleen Clemmer, Akron, OH (US); Kent D. Weatherwax, Akron, OH (US)

(73) Assignee: Bridgestone Americas Tire Operations, LLC, Nashville, TN (US)

(21) Appl. No.: 13/947,695

(22) Filed: Jul. 22, 2013

(51) Int. Cl. B60C 9/20; B60C 13/00; B60C 9/00; B60C 11/00; B60C 9/18; B60C 9/02

(52) U.S. Cl. CPC B60C 9/2003; B60C 9/18; B60C 9/02; B60C 9/00; B60C 11/00; B60C 13/00; B60C 9/0042; B60C 9/0028; B60C 2009/2019; B60C 2009/2022; B60C 2009/2016
USPC 152/535; 152/526

(57) ABSTRACT

A tire includes a carcass ply and at least one annular structure associated with the carcass ply. The tire further includes a metal-free circumferential belt region comprising a first metal-free belt ply and a second metal-free belt ply. The tire also has a metal-free cap ply disposed radially outward of the first metal-free belt ply and the second metal-free belt ply. The tire also includes a metal-free circumferential tread that contacts a road, and a pair of sidewalls associated with at least one annular structure and the metal-free circumferential tread.

### FIELD OF INVENTION

This disclosure relates to the field of tire constructions. More particularly, the disclosure relates to tires made without large amounts of steel or other metal. Even more particularly, the disclosure describes tires made with reduced amounts of steel or other metal in the belts, reinforcements, cap plies, treads, shoulders, and sidewalls.

### BACKGROUND

Current tire constructions employ body plies having reinforcing cords that extend transversely from bead to bead. Such tires are referred to as radial tires, because the reinforcement cords are in a substantially radial orientation. A radial tire employs an inextensible, circumferential belt that contains steel reinforcement cords. The belt is disposed on top of the body plies, below the tread. It had been understood in the art that a steel belt was required in radial tires to prevent undesired expansion of the tire that would result in poor cornering performance. Additionally, prior non-steel tire constructions tend to deform easily and wear faster. Prior non-steel tire constructions are also unable to travel at high speeds. Given these concerns, prior non-steel constructions were not viable alternatives to steel-belted tires.

### SUMMARY OF THE INVENTION

In one embodiment, a tire includes a first annular bead, a second annular bead, and a body ply extending between the first annular bead and the second annular bead. The tire further includes a circumferential belt disposed radially outward of the body ply and extending axially across a portion of the body ply. The tire also has a first reinforcement ply disposed radially outward of the circumferential belt and extending axially across a portion of the body ply. A circumferential tread is disposed radially outward of the first reinforcement ply and extends axially across a portion of the body ply. A first sidewall extends between the first annular bead and a first shoulder. The first shoulder is associated with the circumferential tread. A second sidewall extends between the second annular bead and a second shoulder. The second shoulder is associated with the circumferential tread. The tire has a 1 degree cornering coefficient of between 0.09 and 0.40, and only the first and second annular beads contain metal.

In another embodiment, a tire includes a carcass ply and at least one annular structure associated with the carcass ply. The tire further includes a metal-free circumferential belt region comprising a first metal-free belt ply and a second metal-free belt ply. The tire also has a metal-free cap ply disposed radially outward of the first metal-free belt ply and the second metal-free belt ply. The tire also includes a metal-free circumferential tread that contacts a road, and a pair of sidewalls associated with at least one annular structure and the metal-free circumferential tread.

In yet another embodiment, a tire includes a pair of annular beads configured to secure the tire to a vehicle wheel, and a non-metallic body ply associated with the annular beads. The non-metallic body ply forms a radially inner portion of the tire. The tire further includes a non-metallic annular belt disposed radially outward of the non-metallic body ply. The non-metallic annular belt forms a radially intermediate portion of the tire. A first non-metallic reinforcement further forms a radially intermediate portion of the tire. A second non-metallic reinforcement further forms a radially intermediate portion of the tire. A tread is disposed radially outward of the first and second non-metallic reinforcements, and forms a radially outer portion of the tire. A pair of sidewalls form axially outer portions of the tire.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a peel-away cross-sectional perspective view of an embodiment of a tire;

FIG. 2 is a cross-sectional view of a second embodiment of a tire;

FIG. 3 is a schematic drawing of a cross-sectional view of a representative embodiment of a radial tire;

FIG. 4 is a schematic drawing of a cross-sectional side view of the representative embodiment of the radial tire shown in FIG. 3;

FIG. 5 is a schematic drawing of a cross-sectional top view of ply layers and reinforcement cords disposed in the representative embodiment of the radial tire shown in FIG. 3;

FIG. 6 is a schematic drawing of a cross-sectional view of a representative embodiment of a bias tire;

FIG. 7 is a schematic drawing of a cross-sectional side view of a representative embodiment of the bias tire shown in FIG. 6; and

FIG. 8 is a schematic drawing of a cross-sectional top view of ply layers and reinforcement cords disposed in the representative embodiment of the bias tire shown in FIG. 6.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Radial” and “radially” refer to a direction perpendicular to the axis of rotation of a tire.

“Sidewall” as used herein, refers to that portion of the tire between the tread and the bead.

“Tread” as used herein, refers to that portion of the tire that comes into contact with the road under normal inflation and load.

While similar terms used in the following descriptions describe common tire components, it is understood that because the terms carry slightly different connotations, one of ordinary skill in the art would not consider any one of the following terms to be purely interchangeable with another term used to describe a common tire component.

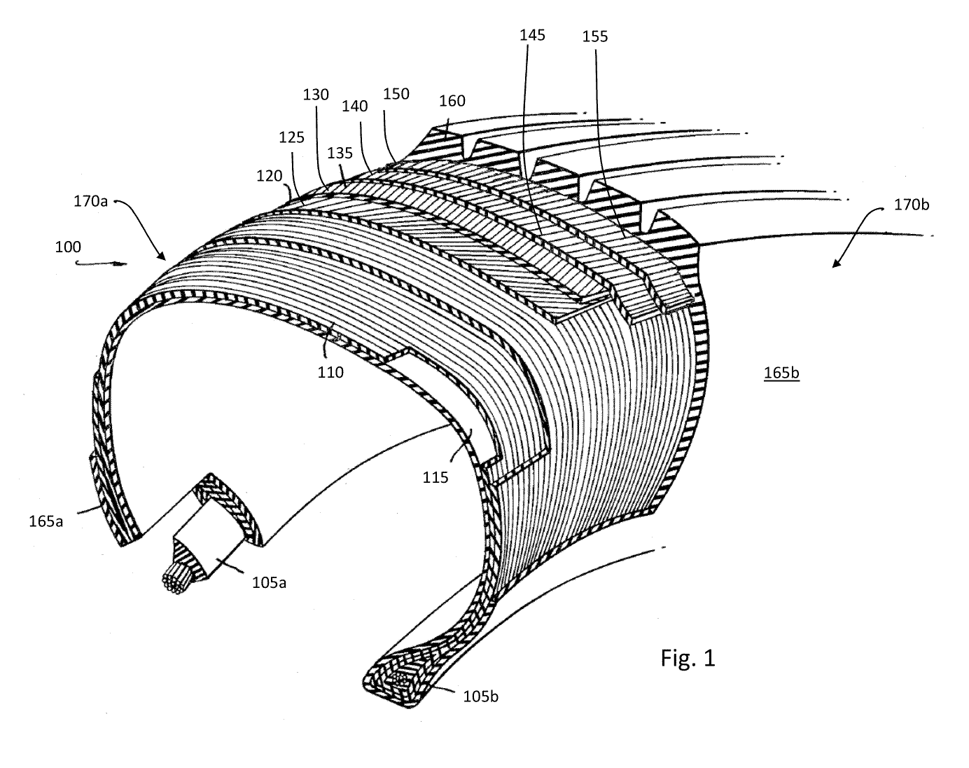

FIG. 1 shows a peel-away cross-sectional perspective view of tire 100. Tire 100 includes a first annular bead 105a and a second annular bead 105b. In the construction shown in FIG. 1, the annular beads 105a and 105b contain metallic cords (not labeled). The annular beads are configured to secure the tire to a vehicle wheel.

Body ply 110 extends between the first and second annular beads 105a,b. As one of ordinary skill in the art would understand, the body ply 110 can extend between and around the pair of annular beads 105a,b in a variety of manners. In alternative embodiments, body ply 110, also known as a carcass ply, is associated with an annular structure such as an annular bead via physical proximity, direct physical contact, industrial mixing process, or chemical interaction. Although not shown, body ply 110 may have a plurality of non-metallic reinforcement cords.

The illustrated embodiment includes an inner liner 115 that is the innermost tire element and is adjacent to body ply 110. In an alternative embodiment (not shown), reinforcement layers or other layers may be disposed between the inner liner and the body ply. In another alternative embodiment (not shown), the inner liner is omitted and the body ply is the innermost tire element.

In additional embodiments, body ply 110 forms a radially inner portion of the tire. Generally speaking, the radially inner portion of the tire constitutes an area between an inner liner and a circumferential belt. The radially inner portion can include, amongst other things: a body ply, an inner liner or other bonding and sealing layers, a noise damper, electronic and/or sensory components, fluid media used to prevent air leakage, and other features or components not specifically recited herein.

A first circumferential belt 120 is disposed radially outward of the body ply 110. The first circumferential belt 120 includes a first plurality of non-metallic reinforcement cords 125. A second circumferential belt 130 is disposed radially outward of the first circumferential belt 120. The second circumferential belt 130 includes a second plurality of non-metallic reinforcement cords 135. In an alternative embodiment, the belt region (i.e., the region containing a circumferential belt and reinforcements such as cap plies and reinforcement plies) contains additional plies that are also devoid of metal and other rigid, slow-decomposing materials.

In additional alternative embodiments not shown herein, the circumferential belt forms a radially intermediate portion of the tire. Generally speaking, the radially intermediate portion of the tire constitutes an area between the body ply and a tread base layer (not shown). The radially intermediate portion can include, amongst other things: belt(s), reinforcement(s), rubber and rubber alternatives, adhesive or bonding layers, electronic and/or sensory components and other features or components not specifically recited herein. Thus, in these additional alternative embodiments, the circumferential belt need not be the sole intermediate tire element, although it can be.

In the embodiment shown in FIG. 1, tire 100 further contains a first reinforcement ply 140 having first reinforcement cords 145 or a first cord substitute (not shown), and a second reinforcement ply 150 having second reinforcement cords 155 or a second cord substitute (not shown). The first reinforcement ply 140 is disposed radially outward of body ply 110, the first circumferential belt 120 and the second circumferential belt 130. The second reinforcement ply 150 is disposed radially outward of first reinforcement ply 140. Both the first and second reinforcement plies 140 and 150 extend axially across a portion of body ply 110. Both first reinforcement ply 140 and second reinforcement ply 150 are devoid of metal and other rigid, slow-decomposing materials. As one of ordinary skill in the art would understand, rigid, slow-decomposing materials may present a safety danger once a tire goes through a recovery or recycling process. In an alternative embodiment not shown in FIG. 1, tire 100 contains no reinforcement plies.

In one alternative embodiment, not shown, tire 100 only contains a first reinforcement ply 140 disposed between circumferential tread 160 and body ply 110.

Circumferential tread 160 is disposed radially outward of first and second reinforcement plies 140, 150. Circumferential tread 160 extends axially across a portion of body ply 110. As shown, circumferential tread 160 extends between the shoulders, although in certain constructions, such as those used for motorcycle tires, the tread can be understood to comprise part of the shoulder or extend beyond a shoulder. Circumferential tread 160 contains no large particulate metal, metal solids, or other metal reinforcement. Large particulate metal includes metal particles similar in size to silt, very fine sand, medium sand, coarse sand, very coarse sand, and very fine gravel.

In alternative embodiments (not shown), the circumferential tread forms a radially outer portion of the tire. Generally speaking, the radially outer portion of the tire constitutes an area between the tread base layer (not shown) and that portion of the tire that comes into contact with the road. A radially outer portion can include, amongst other things: a tread base layer, a tread layer, sprues, metal-free studs or similar traction enhancers, electronic and/or sensory components, fluid media used to prevent air leakage, adhesive or bonding layers, and other features or components not specifically recited herein. Thus, in these additional alternative embodiments, the circumferential tread need not be the sole radially outer tire element, although it may be.

As shown in FIG. 1, first sidewall 165a extends between the first annular bead 105a and a first shoulder 170a. Second sidewall 165b extends between the second annular bead 105b and a second shoulder 170b. The sidewalls, shoulders, and tread are associated via physical proximity, direct physical contact, industrial mixing process, or chemical interaction. As one of ordinary skill in the art would understand, sidewalls 165a and 165b may be made of a different rubber than the tread or other parts of the tire. Sidewalls 165a and 165b may also have various inserts, chippers, flippers, cooling fins, reinforcements, protectors, electronic and/or sensory components, and/or other functional or ornamental features not specifically shown in FIG. 1. In additional embodiments, which may or may not use the sidewall elements described above, the sidewalls 165a and 165b form an axially outer portion of the tire. Thus, in these additional alternative embodiments, the sidewalls 165a and 165b need not be the sole axially outer tire elements, although they may be. Regardless of whether additional sidewall features are utilized in a given construction, the first sidewall 165a and the second sidewall 165b shown in FIG. 1 are metal-free sidewalls. The sidewalls are metal-free sidewalls because they contain no large particulate metal, metal solids, or other metal reinforcement.

Because only the first and second annular beads 105a and 105b of tire 100 contain metal, tire 100 is substantially free of metal.

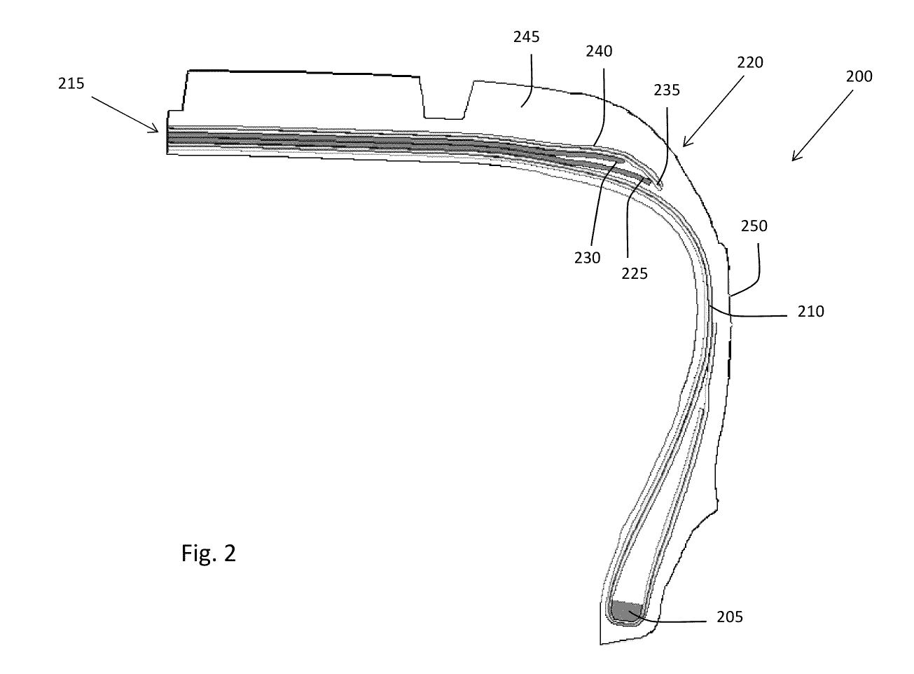

FIG. 2 shows a cross-sectional view of a section of a second embodiment of a tire 200. Tire 200 contains beads 205. The beads, which are a type of annular structure, are configured to secure the tire to a vehicle wheel. It should be understood that other annular structures may be employed instead of beads.

Carcass ply 210, sometimes referred to as a body ply, is associated with beads 205 via physical proximity, direct physical contact, industrial mixing process or chemical interaction. The beads 205 and carcass ply 210 give the tire a toroid shape. In an alternative embodiment not specifically shown in FIG. 2, an inner liner or other component connects beads 205 so that the components form a unitary annular structure. In such an embodiment, the tire would have at least one annular structure. Further, although not shown, an inner liner or other inner coating may be utilized in addition to the carcass ply 210 or single annular structure.

Metal-free circumferential belt 215 occupies belt region 220. In one embodiment, belt region 220 further contains a first metal-free belt ply 225 and a second metal-free belt ply 230. In one alternative embodiment, not shown, metal-free circumferential belt 215 further comprises a second metal-free base ply. In additional alternative embodiments, also not shown, tire 200 contains additional metal-free belt plies.

First metal-free cap ply 235 is disposed radially outward of the metal-free circumferential belt 215. Tire 200 further contains a second metal-free cap ply 240 disposed between the circumferential tread and the carcass ply. In another alternative embodiment, the second metal-free cap ply is disposed between various other plies. In additional alternative embodiments, two or more metal-free cap piles are distributed radially throughout the tire 200.

Metal-free circumferential tread 245 is disposed radially outward of metal-free cap ply 235. Metal-free circumferential tread 245 also extends axially across a surface of tire 200. As shown, metal-free circumferential tread 245 is the radially outermost tire element. Thus, metal-free circumferential tread 245 is a portion of the tire 200 that contacts a road.

In addition to metal-free circumferential tread 245, sidewalls 250 form additional surfaces of tire 200. Sidewalls 250 extend from the edges of metal-free circumferential tread 245 to beads 205. Sidewalls 250 associate with the edges of metal-free circumferential tread 245 via physical proximity, direct physical contact, industrial mixing process, or chemical interaction. In the case of a single annular structure, sidewalls 250 extend from the edges of metal-free circumferential tread 245 to the single annular structure. Sidewalls 250 associate with beads 205 or the single annular structure via physical proximity, direct physical contact, industrial mixing process, or chemical interaction.

In one embodiment, sidewalls 250 are metal-free sidewalls. The sidewalls are metal-free sidewalls because they contain no large particulate metal, metal solids, or other metal reinforcement. In a second embodiment, sidewalls 250 contain a non-metallic reinforcement.

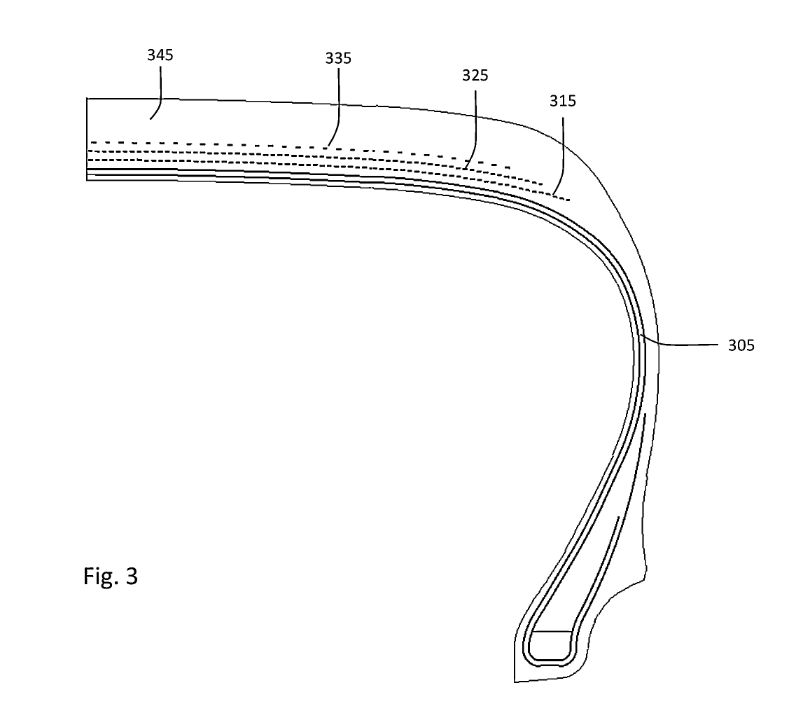

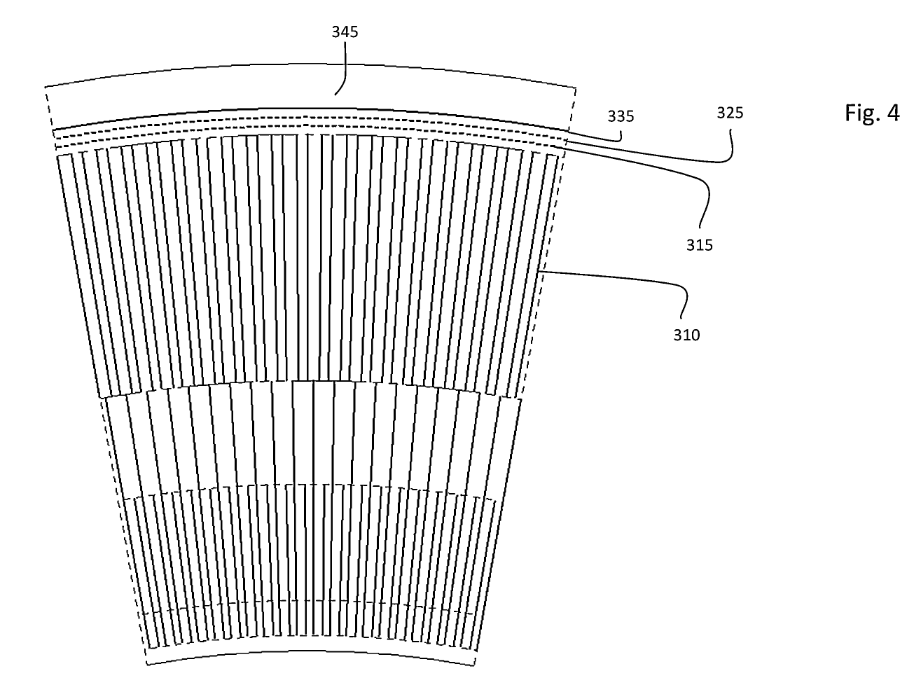

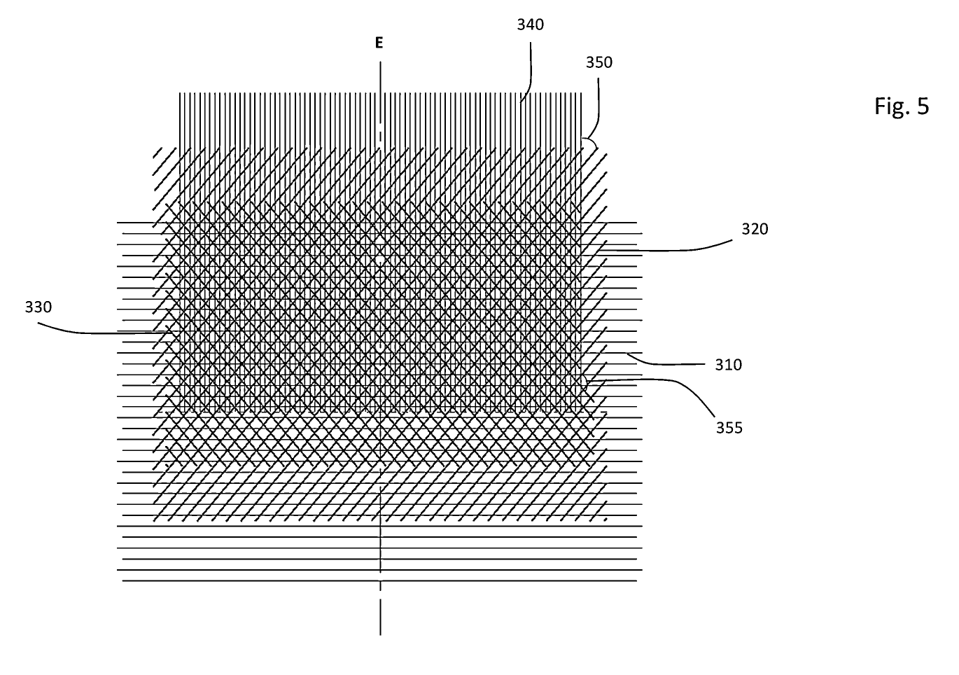

FIG. 3 shows a schematic drawing of a cross-sectional view of an embodiment of a radial tire 300. FIG. 4 is a schematic drawing of a cross-sectional side view of an embodiment of the radial tire 300 depicted in FIG. 3. FIG. 5 is a schematic drawing of a cross-sectional top view of the cords disposed in the radial tire 300 depicted in FIG. 3. The tire 300 is described with reference to FIGS. 3-5.

The tire 300 is substantially the same as the tire 100 described above with reference to FIG. 1, except for the differences described herein. Body ply 305 is disposed radially inward of first reinforcement ply 315. First reinforcement ply 315 is disposed radially inward of second reinforcement ply 325. Cap ply 335 is disposed radially outward of second reinforcement ply 325. Cap ply 335 contains cap ply fibers 340 that run parallel to the tire's equatorial plane, E. Circumferential tread 345 is disposed radially outward of cap ply 335.

Body ply 305 contains body ply cords 310 that extend radially from radial tire 300's bead region toward circumferential tread 345. First reinforcement ply 315 contains first reinforcement cords 320, and second reinforcement ply 325 contains second reinforcement cords 330.

As best shown in FIG. 5, body ply cords 310 generally intersect the tire's equatorial plane, E, at a right angle. However, as one of ordinary skill in the art would understand, body ply cords 310 may also intersect the equatorial plane E at an angle slightly less than or greater to 90 degrees such that tire 300 is still considered a radial tire. Thus, one of ordinary skill in the art would understand that the body ply cords 310 in a radial tire intersect the equatorial plane E at a substantially right angle.

As also shown in FIG. 5, first reinforcement cords 320 intersect the equatorial plane E at a first angle 350, and the second reinforcement cords 330 intersect the equatorial plane E at a second angle 355. In a first embodiment, the first angle is greater than the second angle. In a second embodiment, the first angle is between 45 and 74 degrees and the second angle is between 45 and 74 degrees. In an alternative embodiment, the first angle is greater than the second angle and the first angle is between 45 and 74 degrees and the second angle is between 45 and 74 degrees. In an additional embodiment, the first angle is between 60 and 74 degrees and the second angle is between 60 and 74 degrees. In yet another embodiment, the first angle is greater than the second angle and the first angle is between 60 and 74 degrees and the second angle is between 60 and 74 degrees.

FIG. 3 shows a schematic drawing of a cross-sectional view of an embodiment of a radial tire 300. FIG. 4 is a schematic drawing of a cross-sectional side view of an embodiment of the radial tire 300 depicted in FIG. 3. FIG. 5 is a schematic drawing of a cross-sectional top view of the cords disposed in the radial tire 300 depicted in FIG. 3. The tire 300 is described with reference to FIGS. 3-5.

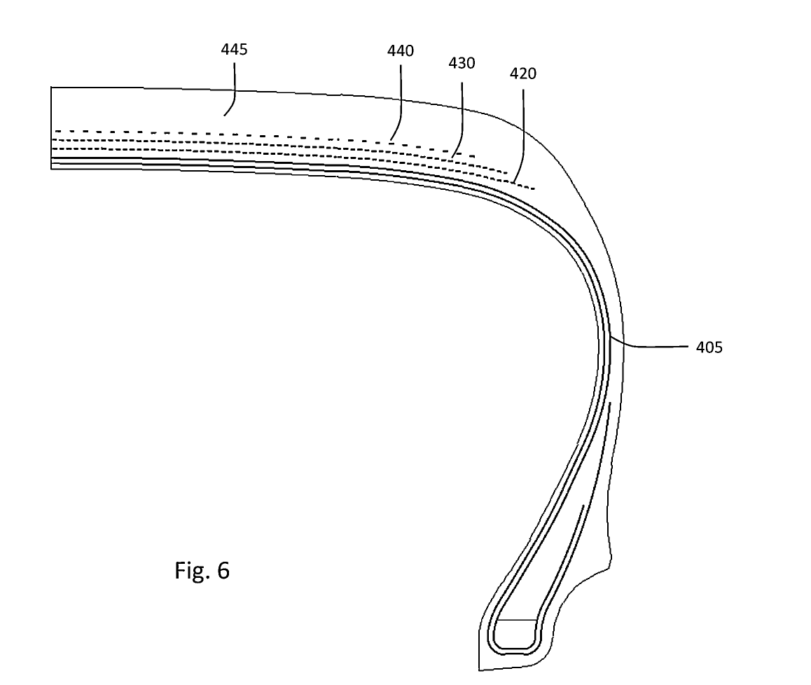

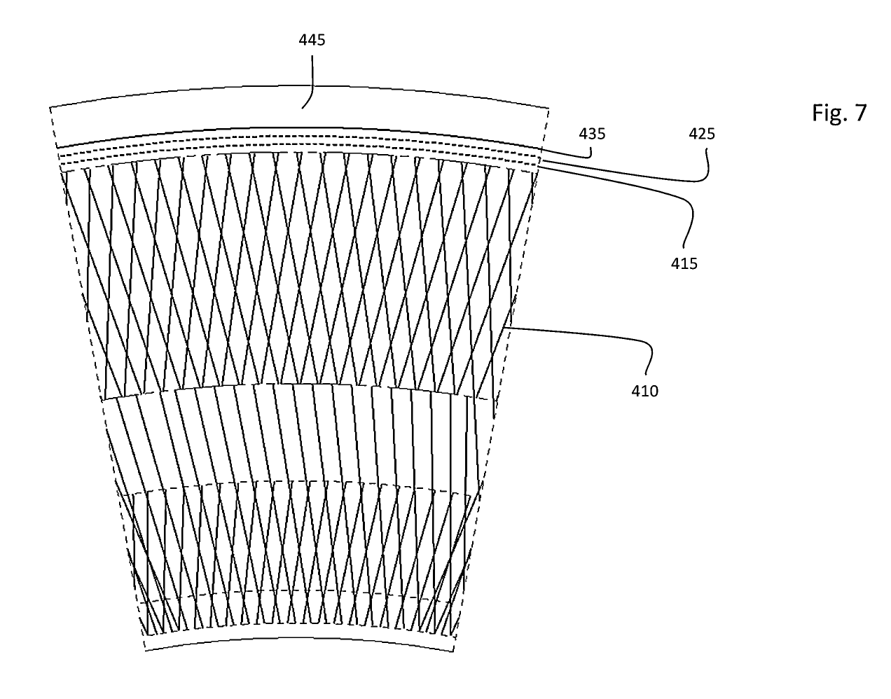

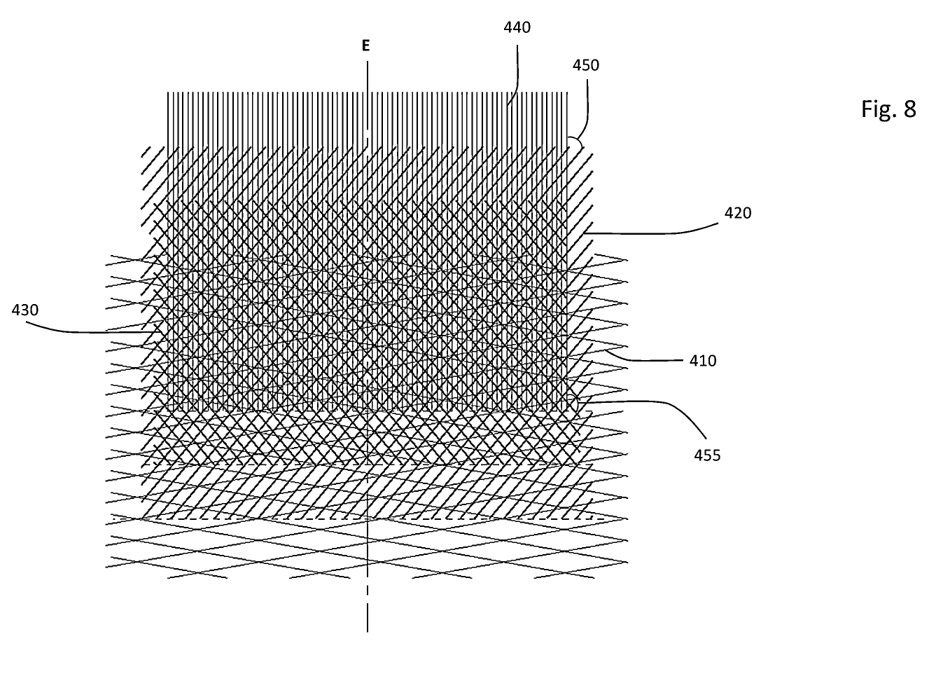

FIG. 6 shows a schematic drawing of a cross-sectional view of an embodiment of bias tire 400. FIG. 7 is a schematic drawing of a cross-sectional side view of an embodiment of the radial tire 400 depicted in FIG. 6. FIG. 8 is a schematic drawing of a cross-sectional top view of the cords disposed in the radial tire 400 depicted in FIG. 6. The tire 400 is described with reference to FIGS. 6-8. The tire 400 is substantially the same as the tire 300 described above with reference to FIGS. 3-5, except for the differences described herein. Body ply 405 is disposed radially inward of first reinforcement ply 415. First reinforcement ply 415 is disposed radially inward of second reinforcement ply 425. Cap ply 435 is disposed radially outward of second reinforcement ply 425. Cap ply 435 contains cap ply fibers 440 that run parallel to the tire's equatorial plane, E. Circumferential tread 445 is disposed radially outward of cap ply 435.

FIG. 7 is a schematic drawing of a cross-sectional side view of an embodiment of the bias tire depicted in FIG. 6. Body ply 405 contains body ply cords 410 that extend at an angle from an annular bead region (not shown) toward circumferential tread 445. First reinforcement ply 415 contains first reinforcement cords 420, and second reinforcement ply 425 contains second reinforcement cords 430.

FIG. 8 is a schematic drawing of a cross-sectional top view of the cords disposed in the radial tire depicted in FIG. 6. As shown in FIG. 8, body ply cords 410 intersect the tire's equatorial plane, E, at an acute angle. In one embodiment, the body ply cords 410 intersect the equatorial plane E at an angle between 1 and 10 degrees. In another embodiment, the body ply cords 410 intersect the equatorial plane E at an angle between 1.5 and 5 degrees. In yet another embodiment, the body ply cords 410 intersect the equatorial plane E at an angle of about 2 degrees.

As also shown in FIG. 8, first reinforcement cords 420 intersect the equatorial plane E at a first angle 450, and the second reinforcement cords 430 intersect the equatorial plane E at a second angle 455. In a first embodiment, the first angle is greater than the second angle. In a second embodiment, the first angle is between 45 and 74 degrees and the second angle is between 45 and 74 degrees. In an alternative embodiment, the first angle is greater than the second angle and the first angle is between 45 and 74 degrees and the second angle is between 45 and 74 degrees. In an additional embodiment, the first angle is between 60 and 74 degrees and the second angle is between 60 and 74 degrees. In yet another embodiment, the first angle is greater than the second angle and the first angle is between 60 and 74 degrees and the second angle is between 60 and 74 degrees.

While the reinforcement plies shown in FIGS. 3-8 have reinforcement cords (320, 330, 420, 430), one of ordinary skill in the art would understand a cord-based reinforcement ply could be replaced with high-density, metal-free reinforcement fibers, a woven fabric ply design, a mesh ply design, a honeycomb ply design, and/or other ply designs and variations thereof. Further, the reinforcements described above may be made of a different materials. Thus, a second reinforcement may be made of a different material than the first reinforcement. When the reinforcements are made of different materials, the reinforcements may be disposed at different angles or the same angle.

Non-metallic materials suitable for use in the above embodiments include, without limitation, synthetic materials such as nylon, rayon, aramid, para-aramid, polyester, polyethylene naphthalate (PEN), polyethylene terephthalate (PET), polyvinyl alcohol (PVOH or PVA), polybenzobisoxazole (PBO or Zylon), ethylene-carbon monoxide copolymer (POK), carbon fiber, and fiberglass. Similar synthetic materials, known within the art, may also be suitable for use in the above embodiments. As one of ordinary skill in the art would further understand, alternative non-metallic materials not specifically identified herein may also be used in the above embodiments. In one embodiment, such alternative materials can also be processed in a tire recovery or recycling process.

In order to demonstrate several embodiments of the present disclosure, the following examples were prepared and tested. The examples should not, however, be viewed as limiting the scope of the invention. The claims will serve to define the invention.

### Examples

Exemplary tires with the six following constructions were built: Tire 1 (a control tire that was previously available) had two steel belts and two cap plies; Tire 2 had two low angle, 45 degree, nylon belts (orientated at opposing angles) and two nylon cap plies; Tire 3 had two nylon belts (orientated at the same angle) and two nylon cap plies; Tire 4 one nylon belt and two nylon cap plies; Tire 5 had no belt and two nylon cap plies; Tire 6 had one nylon belt and four nylon cap plies. The exemplary tires were then subjected to performance tests described below.

The tires were weighed on a scale without a wheel to show a reduction of −0.9 kg (i.e. −6.1%) to −2.3 kg (i.e. −12.5%) relative to the control tire build number 1.

Hydraulic burst testing was conducted by inflating the tire cavity with water until a pressure was achieved at which one or more components of the tire failed and the construction could no longer maintain the pressure. For the reference conventional tire of build 1, the maximum inflation pressure marked on the sidewall was 51 PSI. The builds 2 through 6 ranged from 210PSI (412% of max inflation) to 295 PSI (578% of max sidewall inflation). Thus an inflation safety factor of at least 4 was achieved for all builds 2 through 6.

The ISO Rolling Resistance Coefficient, or RRC, was determined as per the International Standards Organization, or ISO, tire test procedure 28580. The reported value is the tire drag force divided by the tire vertical load. Tire Inflation, Load and Speed are set as per the standard. A lower number indicates lower drag forces on the tire and thus, a reduction in the energy required to overcome this drag force when utilized on a vehicle. For these builds, the RRC is a reduction in drag force between 3% to 9% of the reference tire build 1.

The tires were tested for static spring rate by affixing the tires to a wheel whose width is recommended based on the Tire and Rim Association's reference manual, inflating the tire to 26 PSI and loading the tire to 100% of the Tire and Rim Association's reference manual's recommendation at 26 PSI inflation. During loading, the displacements for corresponding loads were recorded. The slope of that curve at the full load condition is defined as the vertical spring rate and is an indication of carcass stiffness. The units of vertical spring rate in Table 1 are in N/mm. For builds 2-6, the vertical spring rate is a reduction of 4% to 6% relative to the reference build number 1.

Once the tire was loaded, the tire was then deflected laterally (in the direction perpendicular to the axis of rotation), and the lateral force and displacement was recorded. The calculated slope of the load deflection curve at lateral load equal to zero is known as the lateral spring rate. The lateral load was relieved and the tire was loaded in the fore/aft direction (perpendicular to the lateral direction and in the direction of travel of the tire).

Fore/aft spring rate is calculated using the same method as the lateral spring rate and the units for both are the same as vertical spring rate. The lateral spring rate is an indicator of the tires capability to generate lateral fore as a steering angle is applied to steer the vehicle. There is a reduction in lateral spring rate of 24% to 45%. The fore/aft spring rate is an indication of the ability of a tire to generate acceleration or braking forces when the vehicle operator desires to go or stop. The fore/aft spring rate is reduced more so than the vertical spring rate but not as much as the lateral spring rate. The for/aft spring rate is reduced between 7% to 11% of the reference build 1.

Based on the results in Table 1 and 2, builds 2 and 3, which only substitute the steel belts of the control with low angle nylon belts are able to deliver a 9% reduction in mass with a 6% to 7% reduction in Rolling Resistance while having a small reduction in Vertical and Fore-Aft spring rate. However, builds 2 and 3 have a 24% reduction in lateral stiffness which can impact the ability of the vehicle to generate cornering force. In order to define the full impact to the cornering capability of the tire, additional testing was conducted.

TABLE 1

| Tire | Mass | Hydraulic Burst Pressure | Rolling Resistance Coefficient | Lateral Stiffness | Fore/Aft Stiffness | Vertical Stiffness |
|---|---|---|---|---|---|---|
| Build | (kg) | (PSI) | (ISO Rolling Res. Coefficient) | (Static Spring) | (Static Spring) | (Static Spring) |
| 1 | 14.8 | — | 0.0118 | 206 | 436 | 252 |
| 2 | 13.4 | 240 | 0.0110 | 156 | 394 | 240 |
| 3 | 13.4 | 230 | 0.0111 | 157 | 405 | 242 |
| 4 | 12.9 | 215 | 0.0108 | 138 | 392 | 241 |
| 5 | 12.5 | 210 | 0.0107 | 113 | 387 | 238 |
| 6 | 13.9 | 295 | 0.0114 | 135 | 396 | 242 |

TABLE 2

| Tire | Mass | Hydraulic Burst Pressure | Rolling Resistance Coefficient | Lateral Stiffness | Fore/Aft Stiffness | Vertical Stiffness |
|---|---|---|---|---|---|---|
| Build | (% Control) | (% Control) | (% Control) | (% Control) | (% Control) | (% Control) |
| 1 | 100 | — | 100 | 100 | 100 | 100 |
| 2 | 91 | — | 93 | 76 | 90 | 95 |
| 3 | 91 | — | 94 | 76 | 93 | 96 |
| 4 | 87 | — | 92 | 57 | 90 | 96 |
| 5 | 84 | — | 91 | 55 | 89 | 94 |
| 6 | 94 | — | 97 | 66 | 91 | 96 |

Tables 3 and 4 show the result of testing the dynamic cornering capability of the tires. An MTS flat track machine was utilized to roll the tires mounted on wheels specified in the aforementioned testing and loaded to the same load as specified in the load deflection testing. For this test, the tire inflation was changed from a low level of 15 PSI to a middle range level of 30 PSI, which is representative of many commercially available passenger car vehicles. The tire inflation level was also changed to an elevated inflation level of 45 PSI. While affixed to the test machine, the tire was turned at a constant rate of 5 miles per hour. The machine applied a slip angle to the tire by slowly rotating it about an axis of the center of the tire contact patch through the center of the wheel to an angle of 1 degree. At this angle, the tire generated a lateral force due to out of plane bending of the tire carcass. This force level was then recorded. The tire was then turned in the opposite angle 1 degree from straight ahead rotation, and the force was again recorded.

The tire cornering coefficient, or CC was then calculated by averaging the two force levels at a positive and negative rotation of 1 degree and then dividing that number by the vertical load of the tire. For example, if a tire had a CC of 0.30 and the tire was loaded to 1000 lbs, when 1 degree of slip angle was applied, the tire, on average generated 300 lbs of lateral force.

Under most day-to-day driving maneuvers, tires will operate in a range of 0 to 2 degrees of slip angle. In this range, there is a linear relationship between the input slip angle from the driver turning the wheel to the lateral force generated by the tire to turn the car. Typical ranges of commercially passenger car tires range from 0.25 to 0.45 where 0.25 is representative of a general use tire and 0.45 is representative of a ultra-high performance tire. Like the lateral spring rate already discussed, there is a significant reduction in CC for the tires of builds 2-6 at low inflations of 15 PSI, but as higher inflations (which are more representative of commercially available passenger cars of today), the differential between the reference tire of build 1 and the tires of builds 2-6 is reduced.

If we specifically look at builds 2 and 3 at 30 PSI, we see a reduction of 23% to 31% respectively, but the CC levels of those tires at that condition is 0.30 and 0.28, respectively, which is well within the operational ranges of commercially available passenger car tires. Even at 15 PSI, which is well below any known recommended inflation pressure for a passenger car tire, builds 2 and 3 generated CC levels 0.21 and 0.19 which is only slightly lower than some commercially available passenger car tires.

TABLE 3

| Tire | Corner Coefficient | Corner Coefficient | Corner Coefficient |
|---|---|---|---|
| Build | @ 15 PSI | @ 30 PSI | @ 45 PSI |
| 1 | 0.37 | 0.40 | 0.31 |
| 2 | .021 | 0.30 | 0.30 |
| 3 | 0.19 | 0.27 | 0.28 |
| 4 | 0.16 | 0.24 | 0.26 |
| 5 | 0.09 | 0.15 | 0.19 |
| 6 | 0.17 | 0.23 | 0.24 |

TABLE 4

| | Corner Coefficient | | Corner Coefficient |
|---|---|---|---|
| Tire | @ 15 PSI | Corner Coefficient | @ 45 PSI |
| Build | (% Control) | @ 30 PSI (% Control) | (% Control) |
| 1 | 100 | 100 | 100 |
| 2 | 56 | 77 | 87 |
| 3 | 50 | 69 | 82 |
| 4 | 44 | 61 | 77 |
| 5 | 25 | 38 | 56 |
| 6 | 46 | 59 | 71 |

As one of ordinary skill in the art would understand, the tire embodiments described in this disclosure may be configured for use on a vehicle selected from the group consisting of motorcycles, tractors, agricultural vehicles, lawnmowers, golf carts, scooters, airplanes, military vehicles, passenger vehicles, hybrid vehicles, high-performance vehicles, sport-utility vehicles, light trucks, heavy trucks, heavy-duty vehicles, and buses. One of ordinary skill in the art would also understand that the embodiments described in this disclosure may be utilized with a variety of tread patterns, including, without limitation, symmetrical, asymmetrical, directional, studded, and stud-less tread patterns. One of ordinary skill in the art would also understand that the embodiments described in this disclosure may be utilized in retreading applications.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A tire comprising:
a first annular bead and a second annular bead;
a body ply extending between the first annular bead and the second annular bead;
a circumferential belt disposed radially outward of the body ply and extending axially across a portion of the body ply;
a first reinforcement ply disposed radially outward of the circumferential belt and extending axially across a portion of the body ply;
a circumferential tread disposed radially outward of the first reinforcement ply and extending axially across a portion of the body ply;
a first sidewall extending between the first annular bead and a first shoulder, the first shoulder being associated with the circumferential tread; and
a second sidewall extending between the second annular bead and a second shoulder, the second shoulder being associated with the circumferential tread,
wherein the tire has a 1 degree cornering coefficient of between 0.09 and 0.40, and only the first and second annular beads contain metal.

2. The tire of claim 1, further comprising a second circumferential belt disposed radially between the circumferential belt and the first reinforcement ply.

3. The tire of claim 1, further comprising a second reinforcement ply disposed between the circumferential tread and the body ply.

4. The tire of claim 3, wherein the tire has a 1 degree cornering coefficient of 0.15 to 0.30.

5. The tire of claim 3, wherein the first reinforcement ply has first reinforcement cords that intersect an equatorial plane of the tire at a first angle and the second reinforcement ply has second reinforcement cords that intersect the equatorial plane at a second angle.

6. The tire of claim 5, wherein the first angle is greater than the second angle and both the first and second angles are between 45 and 74 degrees.

7. The tire of claim 6, wherein the first angle is between 60 and 74 degrees and the second angle is between 60 and 74 degrees.

8. The tire of claim 1, wherein the body ply has body ply cords that intersect an equatorial plane of the tire at a substantially right angle.

9. The tire of claim 1, wherein the body ply has body ply cords that intersect an equatorial plane of the tire at an acute angle.

10. The tire of claim 9, wherein the acute angle is between 1 and 10 degrees.

11. The tire of claim 9, wherein the acute angle is about 2 degrees.

12. A tire comprising:
a carcass ply;
at least one annular structure associated with the carcass ply;
a metal-free circumferential belt region, the metal-free circumferential belt region further comprising a first metal-free belt ply and a second metal-free belt ply;
a metal-free cap ply, the metal-free cap ply disposed radially outward of the first metal-free belt ply and the second metal-free belt ply;
a metal-free circumferential tread, the metal-free circumferential tread being a portion of the tire that contacts a road; and
a pair of sidewalls associated with at least one annular structure and the metal-free circumferential tread.

13. The tire of claim 12, wherein the sidewalls are metal-free sidewalls.

14. The tire of claim 12, wherein the first metal-free belt ply contains high-density, metal-free fibers and the second metal-free belt ply also contains high-density, metal-free fibers.

15. The tire of claim 12, wherein the tire is configured to operate at an inflation pressure between 15 and 45 psi.

16. A tire comprising:
a pair of annular beads configured to secure the tire to a vehicle wheel;
a non-metallic body ply associated with the annular beads, wherein the non-metallic body ply forms a radially inner portion of the tire;
a non-metallic annular belt disposed radially outward of the non-metallic body ply, wherein the non-metallic annular belt forms a radially intermediate portion of the tire;
a first non-metallic reinforcement, wherein the first non-metallic reinforcement further forms a radially intermediate portion of the tire;
a second non-metallic reinforcement, wherein the second non-metallic reinforcement further forms a radially intermediate portion of the tire;
a tread disposed radially outward of the first and second non-metallic reinforcements, wherein the tread forms a radially outer portion of the tire; and
a pair of sidewalls, wherein the sidewalls form axially outer portions of the tire.

17. The tire of claim 16, wherein the first non-metallic reinforcement is made from a material selected from the group consisting of nylon, rayon, aramid, para-aramid, polyester, PEN, PET, PVA, PBO, POK, carbon fiber, and fiberglass.

18. The tire of claim 16, wherein the second non-metallic reinforcement is made of a different material than the first non-metallic reinforcement.

19. The tire of claim 16, wherein the first non-metallic reinforcement and the second non-metallic reinforcement are disposed at different angles.

20. The tire of claim 16, wherein the tire is configured for use on a vehicle selected from the group consisting of motorcycles, tractors, agricultural vehicles, lawnmowers, golf carts, scooters, airplanes, military vehicles, passenger vehicles, hybrid vehicles, high-performance vehicles, sport-utility vehicles, light trucks, heavy trucks, heavy-duty vehicles, and buses.
